(19) United States
(12) Patent Application Publication
(10) Pub. No.: US 2003/0222821 A1
(43) Pub. Date: Dec. 4, 2003

(54) Antenna

(76) Inventors: Sami Mikkonen, Oulu (FI); Pekka Vayrynen, Oulu (FI); Ari Kalliokoski, Kello (FI)

Correspondence Address: PERMAN & GREEN, 425 POST ROAD, FAIRFIELD, CT, 06824, US

(21) Appl. No.: 10/376,937

(22) Filed: Feb. 28, 2003

(30) Foreign Application Priority Data
Feb. 28, 2002 (GB) 0204748.8

(51) Int. Cl. H01Q 1/38; H01Q 1/24

(52) U.S. Cl. 343/700 MS; 343/702

(57) ABSTRACT

There is disclosed an antenna, suitable for use in a mobile device such as a mobile station, having a multi-layer radiator surface extending in three dimensions.

### FIELD OF THE INVENTION

The present invention relates to antennas, particularly reflective antennas, and particularly but not exclusively to such antennas for use in mobile devices such as mobile telephones.

### BACKGROUND TO THE INVENTION

An antenna is an essential part of the radio frequency (RF) system of a mobile station (MS) such as a mobile telephone. In certain applications it is desirable to provide antennas internally within the structure of the mobile device rather than externally mounted to it. Internal antennas require space inside a mobile station's physical structure. However providing the antenna within the mobile station, rather than external to the station, creates a conflict with the general desirability to minimise the physical size of the mobile device itself. The general desirability to minimise the size of a mobile station may be limited by providing the antenna within the station.

In addition the size of an internal antenna, and hence the amount of space required within the mobile station, is dependent upon frequency band(s) used by the mobile device. If the amount of space available within the mobile station is limited, then it may not be possible to implement the device at certain frequencies without increasing the size of the device.

Current designs for internal antennas, such as the planar inverted F-antenna (PIFA), tend to require a relatively large amount of space, and therefore limit the physical design of mobile stations.

A further drawback with current internal antennas is the associated manufacturing expense. These antennas need to be assembled during a mobile handset manufacturing process.

It is therefore an aim of the present invention to provide an antenna suitable for use in a mobile station, which can be more efficiently accommodated within a mobile station.

### SUMMARY OF THE INVENTION

By re-shaping a flat radiator of an antenna in three-dimensions, significant benefits are achieved by the present invention.

According to the present invention there is provided an antenna having a multiplayer planar radiator surface. Advantageously the surface area of the radiator surface may be increased without increasing the physical size of the device containing the antenna. Alternatively, the surface area of the radiator surface may be maintained whilst decreasing the physical size of the device containing.

The antenna has a radiator surface extending in three dimensions. The antenna is preferably provided with a ground plane provided opposite the radiator surface. The ground plane may have a planar surface.

The radiator surface may comprise a fractal structure. The radiator surface is defined on a plurality of surfaces of a multi-layer printed wiring board. The radiator surfaces on each layer are preferably interconnected. The multi-layer printed wiring board may further contain components of a wireless device. The wireless device is preferably a wireless telephone handset. A ground plane for the antenna is provided by a further component of the wireless device. There may further be provided a ground plane for the antenna.

The invention also provides a wireless device including an antenna, the antenna having a non-planar radiating surface extending in three dimensions, and a ground plane provided opposite the radiator surface,

The invention further provides a wireless device including an antenna, the antenna having a planar radiator surface, the planar radiator surface comprising a plurality of inter-connected fractal radiators being defined on a plurality of layers of a multilayer PWB.

### BRIEF DESCRIPTION OF THE DRAWINGS

The invention will be best understood by way of example with reference to the accompanying drawings in which:

FIG. 1 illustrates a conventional PIFA antenna with a planar radiator surface;

FIG. 2 illustrates an improved antenna in accordance with a second embodiment of the present invention;

FIGS. 3 and 4 further illustrate the structure of the antenna arrangement of FIG. 6; and

FIGS. 5 and 6 illustrate alternative implementations of a ground plane for the antenna arrangement of FIG. 2.

### DESCRIPTION OF PREFERRED EMBODIMENTS

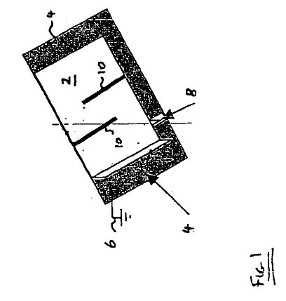

FIG. 1 illustrates an example of an existing planar inverted F-antenna (PIFA) used in current mobile station applications. As shown in FIG. 1, the radiator surface of the antenna comprises a planar surface 2. A ground plane 4, which may be a printed wiring board (PWB), is provided opposite the planar radiator surface 2, connected to a ground point 6. The radiator surface 2 is fed via a feeding point 8. As is also shown in FIG. 1, the radiator surface 2 is provided with two slots or cuts 10 in its surface that are provided, as is known, to adjust the performance of the antenna.

The planar radiating surface 2 is also shown having a perpendicular surface, 12, at its left hand side. The surface 12 connects the radiator surface to the ground plane.

In the known arrangement of FIG. 1, the size of the whole antenna arrangement is determined by the size of the planar radiator surface 2. In turn the size of the planar surface 2 is determined by the radio frequency at which the antenna is required to operate. For example, the size of the radiator surface for a device operating at the 400 MHz is twice the size of the radiator surface for a device operating at 900 MHz

In an integrated antenna, as shown in FIG. 1, the radiation efficiency is dependent on antenna height and on the area of the radiator: as in an external antenna the length is the main parameter.

The present invention is now described with reference to FIGS. 2 to 6. In the described embodiment, the principle of a three-dimensional radiator surface is utilised. In the illustrative embodiment, the antenna is implemented in a multi-layer printed wiring board (PWB).

Referring to FIG. 2, there is illustrated a three-layer PWB 61. The present invention is not limited to a three layer PWB, and the invention may be more broadly applied to a PWB comprising two or more layers. The three layer PWB has a first layer 92, a second layer 94, and a third layer 96.

Each of the three layers is provided with part of the antenna radiator. The radiator in FIG. 2 is illustrated as a radiator string. However the radiators, in other embodiments, may comprise a planar structure. The radiator string can be considered to be a planar structure.

The first layer (the top layer) 92 is provided with an antenna feeding point 98, which in this embodiment forms an L-shape structure. As can be seen the radiator string on the first layer therefore comprises the string 60, and also comprises the two strings 62 and 64. The second layer 94 comprises four radiator strings 66, 67, 68 and 70. The third layer 96 comprises six radiator strings, 72, 74, 76, 78, 80, and 82. The PWB structure is also provided with vias 90 which interconnect the radiator strings of the three layers.

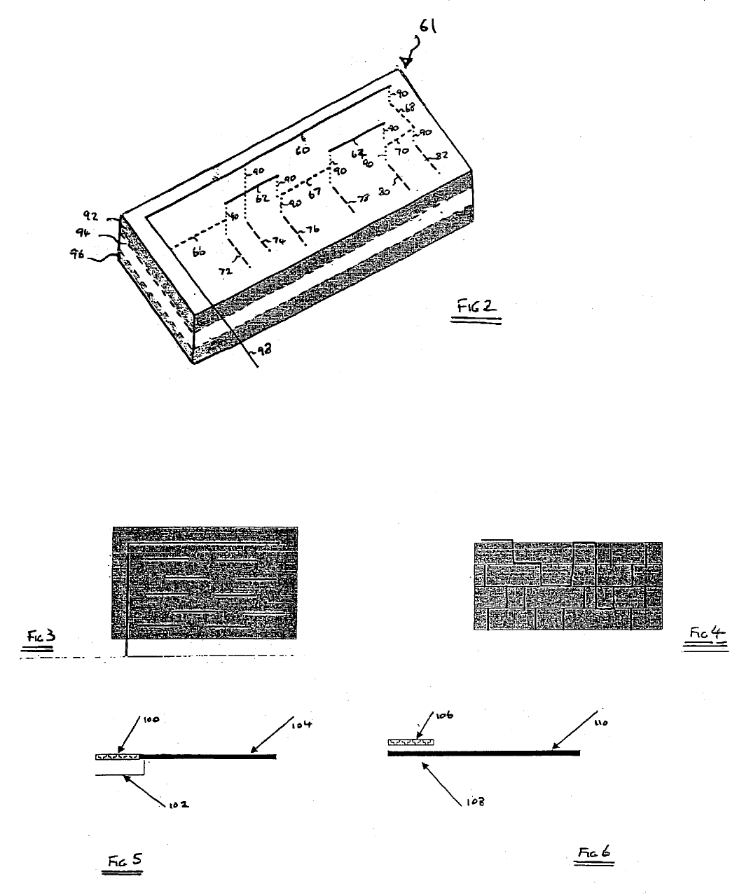

Referring to FIGS. 3 and 4, there is further illustrated the multi-layer PWB antenna. FIG. 3 shows a top view of the antenna structure, showing the radiator strings on the top surface of the PWB. In FIG. 3 it can be seen that the top surface has more radiator strings than are shown, in FIG. 2. These additional radiator strings are not shown in FIG. 2 for clarity. FIG. 4 shows a cross section through the side of a structure such as FIG. 2, but for a four-layer antenna structure. This cross section shows some of the vias in the device, as well as radiator strings. It should be noted that in FIGS. 3 and 4 all of the shown radiator parts are connected together.

Thus, this embodiment of the invention uses the layers of a multi-layer PWB to provide a fractal structure that performs as the antenna. The electrical length of the antenna is increased by adding a new dimension to the conventional PWB antenna, achieved by utilising the multiple layers and not just the top layer. By using the multiple layers, the antenna can be made smaller, with the length being provided amongst several stacked layers rather than on a single layer.

In a particularly preferred embodiment, this antenna simplifies the production of the antenna, by utilising a PWB provided for the mobile handset's functional circuitry. More generally, the antenna may be constructed within any device using a PWB ordinarily provided in the device. In such a construction, the PWB may be required to be made slightly larger than usual to accommodate the antenna, but this still saves space compared to providing a separate physical unit for the antenna. Thus, this embodiment of the invention not only reduces manufacturing cost, but also results in a smaller handset.

Based on measurements obtained with conventional PIFA antennas, it is known that the radiation efficiency is directly related to the size of the radiator. The amount of improvement decreases when a certain size limit is achieved. By reshaping the antenna in three-dimensions, as proposed by the present invention, the area needed by the antenna can be made smaller whilst still keeping the antenna's electrical length, i.e. it's performance, the same.

A further size benefit can be achieved by utilising another part of the device containing the PWB as the ground plane for the antenna. In the case of a mobile phone handset, the ground plane can be provided by the back side of the device display, for example, or by the cover material of the device.

FIG. 5 illustrates the antenna arrangement of FIG. 2 implemented on a PWB of the device. The PWB 104 has the three-dimensional radiator antenna provided at one end 100 thereof. In this arrangement an additional ground plane 102 is provided for the antenna. As discussed above, the ground plane 102 may be provided by a part of the device housing the antenna.

In an alternative arrangement, the multi-layer PWB antenna structure of FIG. 2 may be provided as a stand-alone antenna structure, to be used in place of a conventional PIFA antenna, with a ground plane provided on the PWB of the device. Such an arrangement is illustrated in FIG. 6, where the PWB antenna, referenced by numeral 106, of FIG. 6 is provided above the device's PWB 110, with the PWB section beneath the PWB antenna forming a ground plane 108

In accordance with the present invention, the radiator surface 20 is non-planar, having a three dimensional shape.

In the present invention, the size of the radiator surface can be varied by utilising the layers of the multi-layer PWB. Advantageously, the PWB already exists in the device for mounting of electronic circuitry, and therefore does not contribute to increasing the overall size of the device. Therefore the size of the radiator surface can be extended utilising the multiple layers of the PWB, without increasing the overall size of the device.

The present invention allows the antenna to be made smaller by increasing the electrical length of the antenna by re-shaping the antenna radiator. In making the antenna smaller, less PWB area (ground plane) is required than a conventional PIFA.

In a PIFA lowering the antenna height (i.e. the distance between the planar radiator surface and the ground plane) typically narrows the bandwidth of the antenna and reducing the antenna area makes the gain smaller. In accordance with the invention the gain is increased for a given antenna size, and maintained whilst without increasing the size of the device in which the antenna is located.

Thus the invention may be advantageously used to:

a) reduce the size of the antenna whilst maintaining the radiator surface area and hence the RF performance; and

b) maintain the size of the antenna whilst increasing the radiator surface area and hence increasing the RF performance by providing a large improvement in the antennas bandwidth.

The advantage provided by (b) is particularly useful in relation to multi-band/multimode phones. An increase in bandwidth gives a good advantage with better performance.

Internal antennas for GSM frequencies using prior art antennas require a relatively big size, for example in the region of 10% of the whole volume of a mobile station handset in some cases. The invention shapes the radiator surface multidimensionally to more effectively improve antenna performance using the existing hardware within the mobile device.

The present invention may be used in any application where a planar antenna, such as a PIFA, is used. It can be particularly advantageously applied in mobile telephone handsets. The application of the invention in mobile telephony is not limited to any particular standard such as GSM.

What is claimed is:

1. An antenna having a multi-layer planar radiator surface.

2. An antenna according to claim 1 wherein the radiator surface comprises a fractal structure.

3. An antenna according to claim 1, wherein the radiator surface is defined on a plurality of surfaces of a multi-layer printed wiring board.

4. An antenna according to claim 3 wherein the radiator surfaces on each layer are interconnected.

5. An antenna according to claim 3 wherein the multi-layer printed wiring board further contains components of a wireless device.

6. An antenna according to claim 5 wherein the wireless device is a wireless telephone handset.

7. An antenna according to claim 5 wherein a ground plane for the antenna is provided by a further component of the wireless device.

8. An antenna according to claim 3 wherein there is further provided a ground plane for the antenna.

9. A wireless device including an antenna, the antenna having a non-planar radiating surface extending in three dimensions, and a ground plane provided opposite the radiator surface,

10. A wireless device including an antenna, the antenna having a planar radiator surface, the planar radiator surface comprising a plurality of inter-connected fractal radiators being defined on a plurality of layers of a multi-layer PWB.
